(19) United States
(12) Patent Application Publication
(10) Pub. No.: US 2021/0182818 A1
(43) Pub. Date: Jun. 17, 2021

(54) METHODS AND SYSTEMS FOR ROBOCALL SPONSOR DETECTION

(71) Applicant: Visa International Service Association, San Francisco, CA (US)

(72) Inventor: Justin Xavier HOWE, San Francisco, CA (US)

(73) Assignee: Visa International Service Association, San Francisco, CA (US)

(21) Appl. No.: 16/714,276

(22) Filed: Dec. 13, 2019

(51) Int. Cl. G06Q 20/16; G06Q 20/42; H04M 3/22

(52) U.S. Cl. CPC G06Q 20/16; H04M 3/2281; G06Q 20/42

(57) ABSTRACT

Systems and methods are disclosed. A method includes accessing a payment account number associated with a phone number that has received a VoIP call, determining a time period of the VoIP call to the phone number, matching the payment account number with a payment account authorization made during the time period, and identifying a merchant bank account that is associated with the payment account authorization. A merchant account holder is identified that is associated with the merchant bank account.

### TECHNICAL FIELD

Embodiments of the disclosure pertain to methods and systems for robocall detection and, in particular, methods and systems for robocall sponsor detection.

### BACKGROUND

A robocall is a phone call that uses a computerized autodialer to deliver a prerecorded message. Robocalls are often associated with political and telemarketing phone campaigns, but can also be used for public-service or emergency announcements. Some robocalls use personalized audio messages to simulate an actual personal phone call.

Robocalls have been described as the scourge of modern civilization due to the hundreds of millions of robocalls that are received annually in the United States. This is possible because modern telecommunication services such as VoIP have made robocalls incredibly cheap, costing fractions of a cent per minute. The availability of turn-key operations further compound the problem. For example, a single person in a modestly equipped office can make millions of calls a day by renting some server space, installing off-the-shelf autodialing software, and paying a VoIP provider to transmit the calls. Some of the software is open source, and VoIP carriers often advertise a month of free service as a way to entice potential customers. Some software companies offer everything that is needed in a single package, literally a robocall starter kit, available for anyone to buy.

Many assume that robocalls are a nuisance, but not a violation of U.S. law. However, robocalls and robo-dialing crossed the line from public nuisance to regulatory violation a decade ago. In particular, in 2009 the Federal Trade Commission enacted the “robocall rule,” which banned most prerecorded telemarketing calls. There were exceptions, though, for things like political campaigns, charities, and debt collection. Thus, banks can continue to inquire about unpaid bills and candidates for political office can continue to solicit votes. A 2018 trial court further defined illegal acts to include cell phone robocalls, robocalls with automated or prerecorded messages and robocalls using fake names or numbers. Recently regulatory actions have resulted in huge damages and fines based on illegal robocalls and for calls to numbers on the do not call registry.

Robocalling is an issue of particular interest to payment system risk teams that operate regulatory compliance programs governing their ecosystem in partnership with government entities. Payment system risk teams investigate, terminate, and penalize merchants and financial institutions that violate U.S. and international laws related to the sale of narcotics, counterfeit goods, child pornography, as well as merchants who obfuscate their lines of business in the pursuit of card acceptance. If financial services companies were to censure merchants for the acceptance of payment accounts subsequent to the use of forbidden marketing techniques (e.g., robocalling), their payment system risk teams could be called upon to manage such responsibilities.

The National Do Not Call registry, which is a database maintained by the U.S. federal government, that lists the telephone numbers of individuals and families who have requested that telemarketers not contact them, has existed for decades in the U.S. Currently, telecom operators are beginning to roll out free and paid subscription call-blocking services. For example, monthly fee based services to block telemarketing calls, free call filtering services that incorporate caller ID for a fee, and free scam and ID block services that includes a fee based premium version. However, the current approaches that rely on telecom action and white lists have proven inadequate.

### BRIEF DESCRIPTION OF THE DRAWINGS

FIG. 1A illustrates is a diagram of a transaction processing system in accordance with an embodiment.

FIG. 1B illustrate operations A-E in a method for detecting robocall sponsors according to an embodiment.

FIG. 2 shows components of a system for detecting robocall sponsors according to an embodiment.

FIG. 3 is a flowchart of a method for detecting robocall sponsors according to an embodiment.

FIG. 4 is a schematic of a computer system according to an embodiment.

### DESCRIPTION OF THE EMBODIMENTS

The embodiments described herein are not intended to be limited to the specific forms set forth herein. The embodiments are intended to cover such alternatives, modifications, and equivalents that are within the scope of the appended claims.

The detailed description that follows includes numerous specific details such as specific method orders, configurations, structures, elements, and connections have been set forth. It is to be understood however that these and other specific details need not be utilized to practice embodiments. In other embodiments, well-known structures, elements, or connections have been omitted, or have not been described in a manner so as not to obscure this description.

Any reference within the specification to “one embodiment” or “an embodiment” is intended to indicate that a particular feature, configuration, structure, or characteristic described in connection with the embodiment is included in at least one embodiment of the present invention. The appearance of the phrase “in one embodiment” in different parts of the specification can refer to different embodiments. Embodiments described as separate or alternative embodiments are not mutually exclusive of other embodiments. Moreover, various features are described which may be included in some embodiments and not by others. In additions, some requirements for some embodiments may not be required for other embodiments.

In the following description, unless indicated otherwise terms such as “accessing” or “determining” or “accessing” or “matching” or “identifying” or the like, refer to the operations and processes of a computer system, or similar electronic computing device that manipulates and transforms data represented as physical (electronic) quantities within the computer system's registers and memories and other computer readable media into other data similarly represented as physical quantities within the computer system memories or registers or other such information storage, transmission or display devices.

### Transaction Processing System

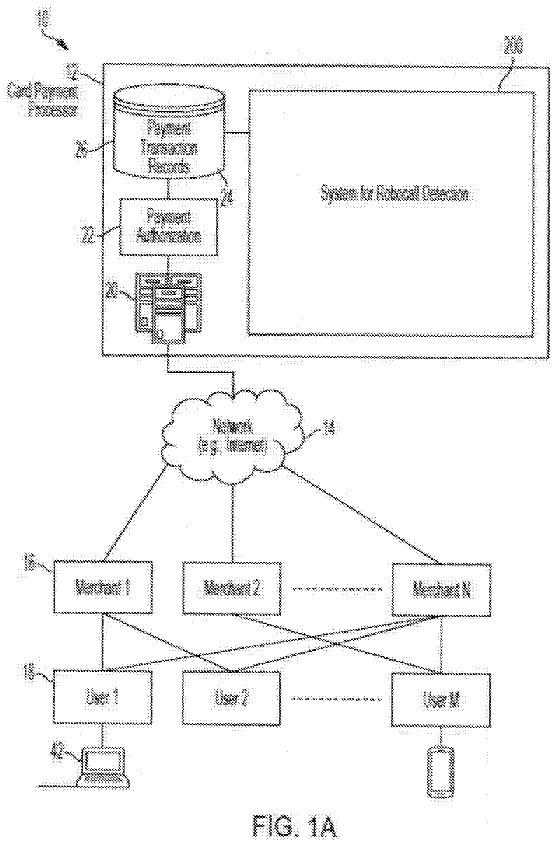

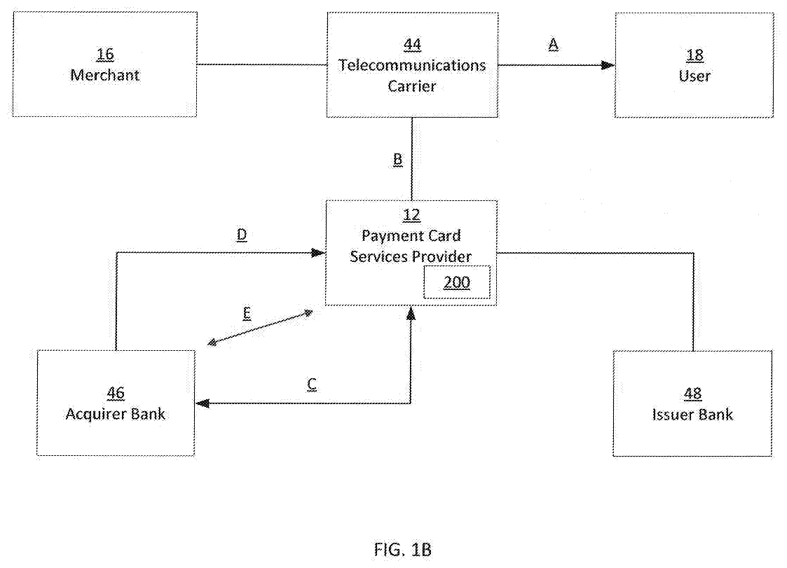

FIG. 1A is a diagram of one embodiment of a card payment processing system in which the disclosed embodiments may be implemented. The card payment processing system 10 includes a card payment processor 12 in communication (direct or indirect) over a network 14 with a plurality of merchants 16. A plurality of cardholders or users 18 purchase goods and/or services from various ones of the merchants 16 using a payment card such as a credit card, debit card, prepaid card and the like. Typically, the card payment processor 12 provides the merchants 16 with a servicer or device that allows the merchants to accept payment cards as well as to send payment details to the card payment processor 12 over the network 14. In some embodiments, an acquiring bank or processor (not shown) may forward the credit card details to the card payment processor 12. Payment card transactions may be performed using a variety of platforms such as brick and mortar stores, ecommerce stores, wireless terminals, and mobile devices of the users. The payment card transaction details sent over the network 14 are received by one or more servers 20 of the card payment processor 12 and processed by, for example, a payment authorization process 22 and/or forwarded to an issuing bank (not shown). The payment card transaction details are stored as payment transaction records 24 in a transaction database 26. As is well known the servers 20 include memory and processors for executing software components as described herein.

The most basic and common type of payment card transaction data is referred to as a level 1 transaction. The basic data fields of a level 1 payment card transaction are: i) merchant name, ii) billing zip code, and iii) transaction amount. Additional information, such as the date and time of the transaction and additional cardholder information may be automatically recorded, but is not explicitly reported by the merchant 16 processing the transaction. A level 2 transaction includes the same three data fields as the level 1 transaction, and in addition, the following data fields may be generated automatically by advanced point of payment systems for level 2 transactions: sales tax amount, customer reference number/code, merchant zip/postal code tax id, merchant minority code, merchant state code. In an embodiment, the card payment processor 12 also includes a system 200 for determining the sponsor (e.g., source) of robocalls that result in payment card transactions that are recorded in payment transaction records 24.

The system 200 identifies the source of robocalls by identifying payment account numbers (PANs) used during VoIP calls, matching the PANs with the bank transactions and identifying the bank account owners associated with the bank transactions. In an embodiment, the PANs include a payment account identifier that identifies the cardholder's designated bank account. In an embodiment, a telecommunications carrier can be used to tie VoIP callers phone numbers to PANs that the cardholders use to pay bills. In an embodiment, the telecommunications company can identify the VoIP calls by phone numbers (recipient's and caller's) and/or call length. It should be appreciated that VoIP calls are of interest because they can be a straightforward way in which a robocaller can mask and/or spoof a telephone number as a means of concealing their identity.

System 200, after accessing the PANs from the telecommunications companies that are identified by phone numbers used to pay bills, identifies the Mail Order/Telephone Order (MOTO)/eCommerce purchases made with these PANs. In an embodiment, payment system authorizations made when a VoIP call is underway with a PAN via telephone can be considered to be very suspicious, and a predetermined number of such authorizations can be used as a basis to trigger further investigation by the administrators of the card payment processing system 10 (e.g., financial services company). In an embodiment, card payment processor 12 MOTO/eCommerce clearing subsequent to a VoIP call may be considered to be less suspicious, but can trigger a merchant investigation if a predetermined number of occurrences of such transactions is exceeded. In an embodiment, as part of the investigation, the financial services company that is associated with the card payment processing system 10 can contact the merchant of record that was linked to the VoIP solicitations.

In an embodiment, a feature of system 200 is its capacity to take advantage of robocall monetization. Monetization is a critical stage in the robocalling ecosystem. In particular, at some point in the robocall communication, payment needs to be received from the consumer or the robocalling campaign cannot be profitable. For example, such a payment can be made in response to a robocaller's indication of the payment types that are acceptable (e.g., types of credit or debit cards). In an embodiment, fake credit card numbers (payment accounts) can be used by financial service company investigators seeking to identify robocallers. In an embodiment, system 200 can identify transactions associated with robocalls whether they are made as mail order/telephone order (MOTO) transactions, or as eCommerce transactions (if the merchant attempted to disguise the acquisition channel).

For example, in an embodiment, system 200 can provide robocall detection even if a robocaller attempts to avoid detection by delaying (or skipping) authorization and proceeding directly to settlement, because the system 200 can tie an eventual payment to an earlier VoIP solicitation. It should be appreciated that the methodology described herein cannot be utilized by telecommunication carriers without a payment network (or large acquirer), as the authorization/clearing/settlement record needs to be seen to utilize such. In an embodiment, the resources of a card payment system can make the method practicable even with the use of tokenization. In an embodiment, the ability of the system 200 to gain access to data from a telecommunications carrier can be based on a partnership with the telecommunications carrier to act as a source of such data.

FIG. 1B shows the parties to transactions that involve robocalls according to an embodiment. FIG. 1B shows card payment processor 12, merchant 16, user 18, telecommunications service provider 44, acquirer bank 46, and issuer bank 48.

Referring to FIG. 1B, card payment processor 12 facilitates electronic funds transfers. In an embodiment, this is done most commonly through company branded credit cards, gift cards, and debit cards.

The issuer bank 48 is the user or cardholder's bank. The issuer bank 48 transfers money for purchases to the acquirer bank 46. In an embodiment, it issues the payment card and holds the user or cardholder's account (such as a credit card account or checking account for a debit card).

Telecommunications carrier 44 is the telephone service provider of the user 18. In an embodiment, the telecommunications carrier 44 can provide the PAN and time that is associated with a suspected robocall to system 200 of the card payment processor 12. In an embodiment, this information can be supplied as a part of VoIP call histories. In an embodiment, the cooperation between the telecommunications carrier 44 and the card payment processor 12 can be facilitated by an agreement between the telecommunications carrier 44 and financial services company that is involved.

The acquirer bank 46 is the merchant's bank. In an embodiment, the acquirer bank 46 accepts payment for purchases. In an embodiment, the card payment processor 12 can identify transactions from the issuer bank 48 to the acquirer bank 46 that involve the user or cardholder's payment account that occur at the time of the VoIP calls identified by the telecommunications carrier 44.

Merchant robocaller 16 is the source of robocalls to the user or cardholder 18. In an embodiment, the merchant robocaller 16 can sell goods and services and accept credit, debit or prepaid cards as promise for payment. In an embodiment, a VoIP service can be used to mask the economic beneficiary of the calls by randomization and spoofing. Randomization involves the random generation of calls. Moreover, spoofing involves the practice of causing the telephone network to indicate to the receiver of a call that the originator of the call is different from the true originating station.

### Operation

FIG. 1B illustrate operations A-E in a method for detecting robocall sponsors according to an embodiment.

At operation A, a VoIP call to a phone number associated with a PAN used to pay phone bills is identified. In an embodiment, based on records, the telecommunications carrier 44 can tie phone numbers to the PANs that their customers use to pay their telephone bills. In an embodiment, the PAN and the time of the call can be provided to system 200 as described with reference to B.

At operation B, the PAN and the time period of the VoIP call to the phone number is accessed by system 200. In an embodiment, the PANs and the time periods of VoIP calls enable system 200 to the identify corresponding merchant bank account transactions associated with the PANs and time periods. For example, system 200 can identify such transactions by reviewing transaction records to determine the transactions associated with a PAN that occurred during the time period of the VoIP call.

At operation C, the PAN received from the telecommunications carrier 44 is matched with payment account authorizations that are made during the call period. In an embodiment, in order to match a PAN with a payment account authorization, system 200 reviews transaction records to identify the payment account authorization associated with the PAN that occurred during the VoIP call period.

At operation D, a merchant bank account of the acquirer bank 46 that is associated with the payment account authorization is identified. In particular, the merchant bank account that is associated with the payment account authorization made during the time period that the VoIP call was made is identified. In an embodiment, the merchant bank account can be the bank account of the merchant 16 that is responsible for the VoIP call.

At operation E, a merchant account holder corresponding to the merchant bank account that is associated with the payment account authorization is identified. For example, after the merchant bank account that is associated with the VoIP call has been identified, the owner of the merchant bank account can be determined to identify the merchant account holder. In an embodiment, the identity of the merchant account holder is the merchant 16 responsible for the VoIP call. In an embodiment, after this merchant of record is identified, the financial services company associated with the payment account can contact the merchant 16.

### Components of System for Robocall Sponsor Detection

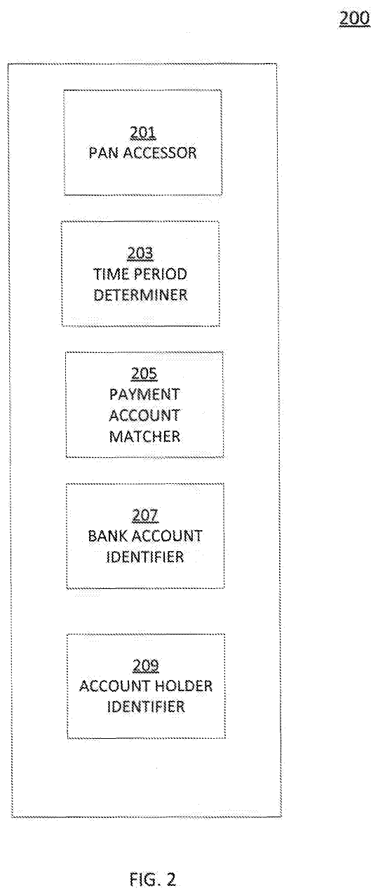

FIG. 2 shows components of a system 200 for detecting robocall sponsors according to an embodiment. System 200 includes PAN accessor 201, time period determiner 203, payment account matcher 205, bank account identifier 207 and account holder identifier 209.

Referring to FIG. 2, PAN accessor 201 accesses a payment account number associated with a phone number that has received a VoIP call. In an embodiment, the VoIP calls can be associated with robocalls as described herein. In an embodiment, a telecommunications carrier (e.g., 44 in FIG. 1B) can tie such phone numbers to payments accounts that their customers have previously used to pay their telephone bills. In an embodiment, these payment account numbers can be accessed from the telecommunications carrier by system 200 via PAN accessor 201. In an embodiment, the telecommunications carrier can identify VoIP calls received based on the telephone number and/or call length. In other embodiments, the telecommunications carrier can identify VoIP calls in other manners.

Time period determiner 203 determines time periods of the VoIP calls to the phone numbers. In an embodiment, the time periods of the VoIP calls enable system 200 to identify corresponding merchant bank account transactions. For example, system 200 can identify such transactions by reviewing transaction records to determine transactions occurring during the time period of the VoIP calls.

Payment account matcher 205 matches PANs with payment account authorizations occurring during the VoIP call periods. In an embodiment, in order to match a PAN with a payment account authorization, payment account matcher 205 reviews transaction records to identify the payment account authorization associated with the PAN that occurred during the VoIP call period.

Bank account identifier 207 identifies a merchant bank account that is associated with a payment account authorization. In an embodiment, the merchant bank account that is associated with a payment account authorization made during a time period that a VoIP call is made is identified. In an embodiment, the merchant bank account is considered to be a bank account of a merchant that is responsible for the VoIP call.

Account holder identifier 209 identifies a merchant account holder corresponding to the merchant bank account associated with a payment account authorization. In an embodiment, after the merchant bank account that is associated with the VoIP is identified, the owner of the merchant bank account can be determined in order to identify the merchant account holder. In an embodiment, the identity of the merchant account holder can be considered to be the merchant responsible for the VoIP call. In an embodiment, after this “merchant of record” is identified, the financial services company associated with the payment account can contact the merchant as potentially being responsible for a robocall solicitation.

FIG. 2 illustrates an example manner of implementing the system 200 of FIG. 1A. In an embodiment, one or more of the elements, processes, components and/or devices of the system 200 may be integrated, separated, re-arranged, omitted, eliminated and/or implemented in other manners. In an embodiment, the components of system 200 can be implemented using hardware, software, firmware and/or any combination thereof. In particular, components of system 200 can be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). In an embodiment, as regards software and/or firmware implementation of the system 200, at least one of the components of such is/are hereby expressly defined to include a non-transitory computer readable storage device or storage disk such as a memory, a digital versatile disk (DVD), a compact disk (CD), a Blu-ray disk, etc. including the software and/or firmware. It should be appreciated that, the example system 200 can include one or more elements, processes and/or devices in addition to, or instead of, those illustrated in FIG. 2, and/or may include more than one of any or all of the illustrated elements, processes and devices.

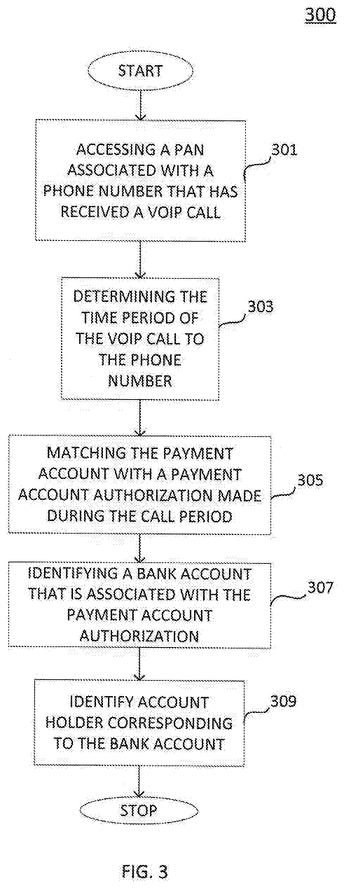

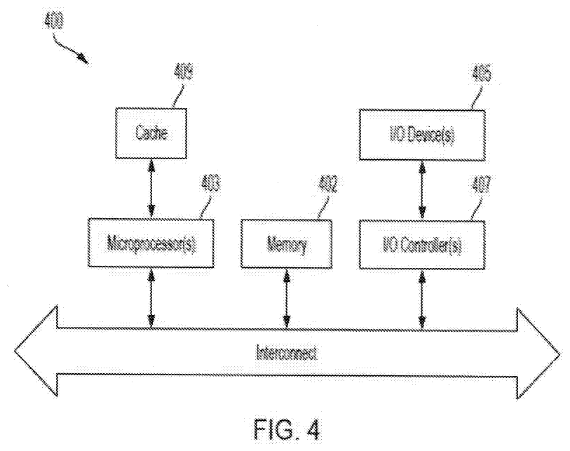

FIG. 3 is a flowchart of a method for performing the operations of the system 200 of FIG. 2. In an embodiment, the operations can correspond to machine readable instructions of a program that can be executed by a processor of a computer system 400 such as is discussed with regard to FIG. 4 below. In some embodiments, the program and/or portions or parts thereof can be executed by a device other than a processor. The program can be stored on a non-transitory machine or computer readable storage medium such as a hard drive, a digital versatile disk (DVD), a read-only memory, a compact disk, a floppy disk, a Blu-ray disk, a cache, a random-access memory or other storage device. As used herein, the term non-transitory computer readable medium is intended to refer to computer readable storage devices and/or storage disks and to exclude propagating signals and to exclude transmission media. In some embodiments, the program can be embodied in firmware or dedicated hardware. In an embodiment, one or more of the operations of the flowchart can be performed without executing software or firmware. For example, one or more of the blocks may be implemented by one or more hardware circuits such as a Field Programmable Gate Array (FPGA), an Application Specific Integrated circuit (ASIC), a discrete and/or integrated analog and/or digital circuit, a comparator, an operational-amplifier (op-amp), a logic circuit, etc. It should be noted that the order of execution of the blocks of the flowchart of FIG. 3 may be changed. In addition, one or more of the blocks of the flowchart can be eliminated or added.

Referring to FIG. 3, the method includes, at 301 accessing a payment account number associated with a phone number that has received a VoIP call. At 303, determining a time period of the VoIP call to the phone number. At 305, matching the payment account with a payment account authorization made during the call period. At 307, identifying merchant bank accounts that are associated with the payment account authorizations. At 309, identifying merchant account holders corresponding to the merchant bank accounts.

In an embodiment, it is determined whether the payment account authorization corresponds to a mail order or telephone order (MOTO)/eCommerce transaction. In an embodiment, identifying the merchant account holder includes determining if the merchant account holder is a merchant responsible for a robocall. In an embodiment, a predetermined number of account authorizations is used to trigger the identifying of the merchant account holder. In an embodiment, the time period of the VoIP call is determined based on a timestamp associated with the VoIP call. In an embodiment, the payment account authorization corresponds to a completed credit or debit card payment. In an embodiment, the VoIP call is distinguished by call length.

FIG. 4 shows a computer system 400 according to an embodiment. The computer system 400 can include a microprocessor(s) 403 and memory 402. In an embodiment, the microprocessor(s) 403 and memory 402 can be connected by an interconnect 401 (e.g., bus and system core logic). In addition, the microprocessor 403 can be coupled to cache memory 409. In an embodiment, the interconnect 401 can connect the microprocessor(s) 403 and the memory 402 to input/output (I/O) device(s) 405 via I/O controller(s) 407. I/O devices 405 can include a display device and/or peripheral devices, such as mice, keyboards, modems, network interfaces, printers, scanners, video cameras and other devices known in the art. In an embodiment, (e.g., when the data processing system is a server system) some of the I/O devices 405, such as printers, scanners, mice, and/or keyboards, can be optional.

In an embodiment, the interconnect 401 can include one or more buses connected to one another through various bridges, controllers and/or adapters. In one embodiment, the I/O controllers 407 can include a USB (Universal Serial Bus) adapter for controlling USB peripherals, and/or an IEEE-1394 bus adapter for controlling IEEE-1394 peripherals.

In an embodiment, the memory 402 can include one or more of: ROM (Read Only Memory), volatile RAM (Random Access Memory), and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, a magnetic optical drive, an optical drive (e.g., a DV D RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, execut-ing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of the present disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of an application claiming priority to this provisional application to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A computer-implemented method, the method comprising:
accessing a payment account number associated with a phone number that has received a voice over internet protocol (VoIP) call;
determining a time period of the VoIP call to the phone number;
matching the payment account number with a payment account authorization made during the time period;
identifying a merchant bank account that is associated with the payment account authorization; and
identifying a merchant account holder that is associated with the merchant bank account.

2. The method of claim 1, further comprising determining whether the payment account authorization corresponds to a mail order or telephone order (MOTO)/eCommerce transaction.

3. The method of claim 1, wherein the identifying the merchant account holder includes determining if the merchant account holder is a merchant responsible for a robocall.

4. The method of claim 1, wherein a predetermined number of account authorizations is used to trigger the identifying of the merchant account holder.

5. The method of claim 1, wherein the time period of the VoIP call is determined based on timestamps associated with the VoIP call.

6. The method of claim 1, wherein the payment account authorization corresponds to a completed prepaid card, credit card, or debit card payment.

7. The method of claim 1, wherein the VoIP call is distinguished by call length.

8. A computer system, comprising:
one or more processing components;
one or more data storage components, at least one of the one or more data storage components including instructions that when executed cause at least one of the one or more processing components to:
accessing a payment account number associated with a phone number that has received a VoIP call;
determining a time period of the VoIP call to the phone number;
matching the payment account number with a payment account authorization made during the time period;
identifying a merchant bank account that is associated with the payment account authorization; and
identifying a merchant account holder that is associated with the merchant bank account.

9. The computer system of claim 8, further comprising determining whether the payment account authorization corresponds to a MOTO/eCommerce transaction.

10. The computer system of claim 8, wherein the identifying the merchant account holder includes determining if the merchant account holder is a merchant responsible for a robocall.

11. The computer system of claim 8, wherein a predetermined number of account authorizations is used to trigger the identifying of the merchant account holder.

12. The computer system of claim 8, wherein the time period of the VoIP call is determined based on timestamps associated with the VoIP call.

13. The computer system of claim 8, wherein the payment account authorization corresponds to a completed prepaid card, credit card or debit card payment.

14. The computer system of claim 8, wherein the VoIP call is distinguished by call length.

15. A computer-readable medium comprising computer readable instructions which when executed, cause a processor to at least:
accessing a payment account number associated with a phone number that has received a VoIP call;
determining a time period of the VoIP call to the phone number;
matching the payment account number with a payment account authorization made during the time period;
identifying a merchant bank account that is associated with the payment account authorization; and
identifying a merchant account holder that is associated with the merchant bank account.

16. The computer-readable medium of claim 15, further comprising determining whether the payment account authorization corresponds to a MOTO/eCommerce transaction.

17. The computer-readable medium of claim 15, wherein the identifying the merchant account holder includes determining if the merchant account holder is a merchant responsible for a robocall.

18. The computer-readable medium of claim 15, wherein a predetermined number of account authorizations is used to trigger the identifying of the merchant account holder.

19. The computer-readable medium of claim 15, wherein the time period of the VoIP call is determined based on timestamps associated with the VoIP call.

20. The computer-readable medium of claim 15, wherein the payment account authorization corresponds to a completed prepaid card, credit card or debit card payment.
